(19) United States
(12) Patent Application Publication
(10) Pub. No.: US 2005/0186941 A1
(43) Pub. Date: Aug. 25, 2005

(54) Verification of telematic unit in fail to voice situation

(75) Inventors: Thomas A. Gault, Clawson, MI (US); Daniele Nicolini, Livonia, MI (US); Bruce A. Groskreutz, Grand Blanc, MI (US); Anton Thevasahayam, Rochester Hills, MI (US); John L. Dale, Fenton, MI (US)

Correspondence Address: General Motors Corporation;Mail Code 482-C23-B21, 300 Renaissance Center, P.O. Box 300, Detroit, MI, 48265-3000, US

(73) Assignee: General Motors Corporation

(21) Appl. No.: 10/775,296

(22) Filed: Feb. 10, 2004

(51) Int. Cl. H04Q 7/20

(52) U.S. Cl. 455/411; 455/456.1; 455/575.9

(57) ABSTRACT

A method of verifying a telematics unit, the method including initiating a cleared number voice call from a telematics unit to a call center based on a failed transmission condition establishing a cleared number voice call communication channel between the telematics unit and the call center; and communicating at least one telematics unit identifier to the call center via the established communication channel.

### FIELD OF THE INVENTION

This invention relates generally to verifying information for vehicles having installed telematics systems. In particular the invention relates to verifying information for vehicles having installed telematics systems in the case of a failed authenticating voice call.

### BACKGROUND OF THE INVENTION

Information and interactive services available to mobile vehicles are increasing due to the demand of mobile vehicle operators for services such as navigation assistance, directory assistance, vehicle maintenance assistance, roadside assistance, information services assistance and emergency assistance. These services are accessible via interfaces such as voice-recognition computer applications, touch-screen computer displays, computer keyboards, or a series of buttons on the dashboard or console of a vehicle.

Currently, telematics service call centers, in-vehicle compact disk (CD) or digital video display (DVD) media, web portals, and voice-enabled phone portals provide various types of location services, including driving directions, stolen vehicle tracking, traffic information, weather reports, restaurant guides, ski reports, road condition information, accident updates, street routing, landmark guides, and business finders.

For example, traffic and driving directions can be accessed through a voice portal that uses incoming number identification to generate location information based on the area code or prefix of the phone number, or to access location information stored in a user's profile associated with the phone number. Users can be prompted to enter more details through a voice interface. Other examples are web and wireless portals that offer location-based services such as maps and driving directions where the user enters both a start and end addresses. Some of these services can have a voice interface.

When a user initiates a communication with an advisor in the call center the communication is established over an authenticated communication channel. An authenticated channel allows the cellular carrier to bill the appropriate person for use of the communication channel and it provides the call center with pertinent information about the vehicle having the installed telematics system. Pertinent information includes the vehicle identification number, the vehicle location, station identification for the telematics unit, the mobile identification number, the mobile dialable number and the button, which was pushed by the user.

If an authenticated call is not established after a number of attempts, a cleared number voice call is made to open a cleared number communication channel. Cleared number voice calls have a higher probability of being connected than authenticated calls. The authenticated can fail to be established for a number of reasons, including a vehicle modem error, a call center modem error, or a vehicle number programming error. When a cleared number voice call is established with the call center of a telematics system, the advisor at the call center asks a series of questions of the user in order to obtain the needed vehicle identification. This takes time and reduces the benefit of using a telematics system.

It is desirable, therefore, to provide a computer usable medium to reduce the time required for an advisor at a call center to obtain the needed vehicle identification after a cleared number communication channel is established, thus overcoming the limitations described above.

### SUMMARY OF THE INVENTION

One aspect of the present invention provides a method of verifying a telematics unit, the method including initiating a cleared number voice call from a telematics unit to a call center based on a failed transmission condition establishing a cleared number voice call communication channel between the telematics unit and the call center; and communicating at least one telematics unit identifier to the call center via the established communication channel.

Another aspect of the present invention provides means for verification of a telematics unit including means for initiating a cleared number voice call from a telematics unit to a call center based on a failed transmission condition, means for establishing a cleared number voice call communication channel between the telematics unit and the call center and means for communicating at least one telematics unit identifier to the call center responsive to the established cleared number voice call.

A third aspect of the present invention provides a computer readable medium storing a computer program including computer readable code for initiating a cleared number voice call from the telematics unit to the call center based on a failed transmission condition, computer readable code for establishing a cleared number voice call communication channel between the telematics unit and the call center and computer readable code for communicating at least one telematics unit identifier to the call center responsive to the established cleared number voice call.

The forgoing device and other devices as well as features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

The present invention is illustrated by way of example and not limited in scope to the accompanying figures, in which like references indicate similar elements, and in which:

FIG. 1 is a schematic diagram of a system for providing access to a telematics unit in a mobile vehicle;

FIG. 2 is a schematic diagram of an embodiment of a system for providing access to a telematics unit in a mobile vehicle in accordance with the present invention;

FIG. 3 illustrates a flowchart representative of a portion of an embodiment of a method of verifying a telematics unit in accordance with the present invention;

FIG. 4 illustrates a flowchart representative of a portion of a second embodiment of a method of verifying a telematics unit in accordance with the present invention;

FIG. 5 illustrates a flowchart representative of a portion of a third embodiment of a method of verifying a telematics unit in accordance with the present invention; and

FIG. 6 illustrates a flowchart representative of a portion of a fourth embodiment of a method of verifying a telematics unit in accordance with the present invention.

### DETAILED DESCRIPTION OF THE PRESENTLY PREFERRED EMBODIMENTS

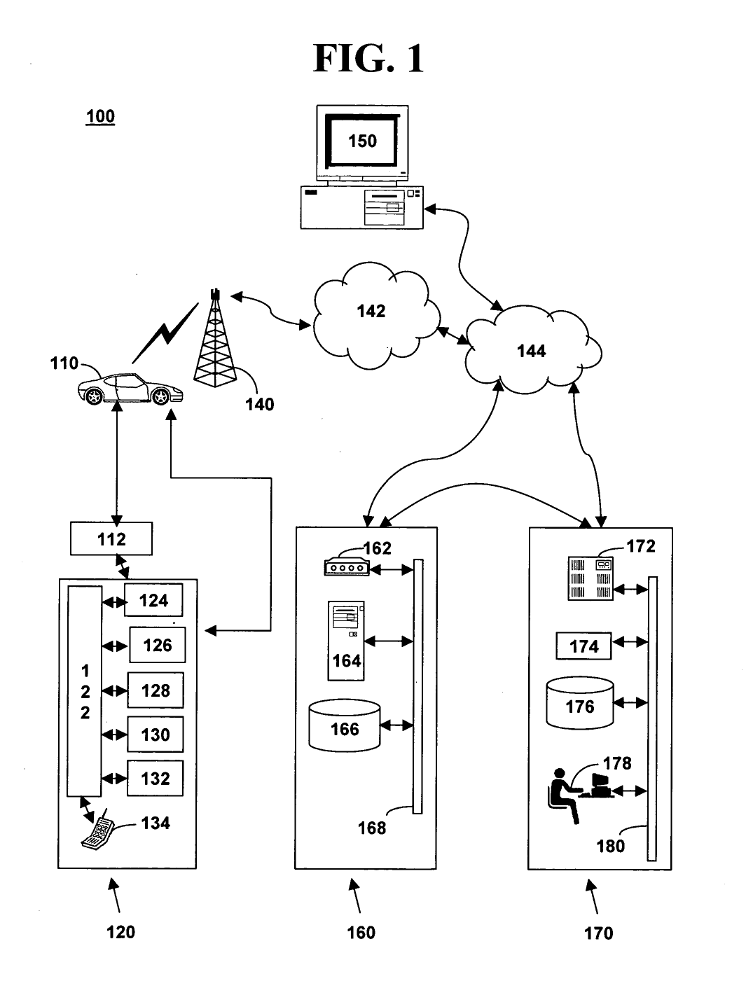

FIG. 1 illustrates one embodiment of a system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. A display may be embedded in MVCU 110. The display may be a dialed digital display, such as, a radio unit or an instrument panel. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a digital signal processor (DSP) 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126 or speakers 132. Telematics unit 120 may include additional components not relevant to the present discussion.

In one embodiment, DSP 122 is implemented as a microcontroller, microprocessor, controller, host processor, or vehicle communications processor. In an example, DSP 122 is implemented as an application specific integrated circuit (ASIC). In another embodiment, DSP 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone.

DSP 122 executes various computer programs that control programming and operational modes of electronic and mechanical systems within MVCU 110. DSP 122 controls communications (e.g. call signals) between telematics unit 120, wireless carrier system 140, and call center 170. In one embodiment, a voice-recognition application is installed in DSP 122 that can translate human voice input through microphone 130 to digital signals. DSP 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from DSP 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, land network 144 and web hosting portals 160 using voice transmissions. In an alternative embodiment, communication services manager 174 communicates with telematics unit 120 in MVCU 110 through wireless carrier system 140, communication network 142, land network 144 and web hosting portals 160 using voice transmissions. Switch 172 selects between voice transmissions and data transmissions.

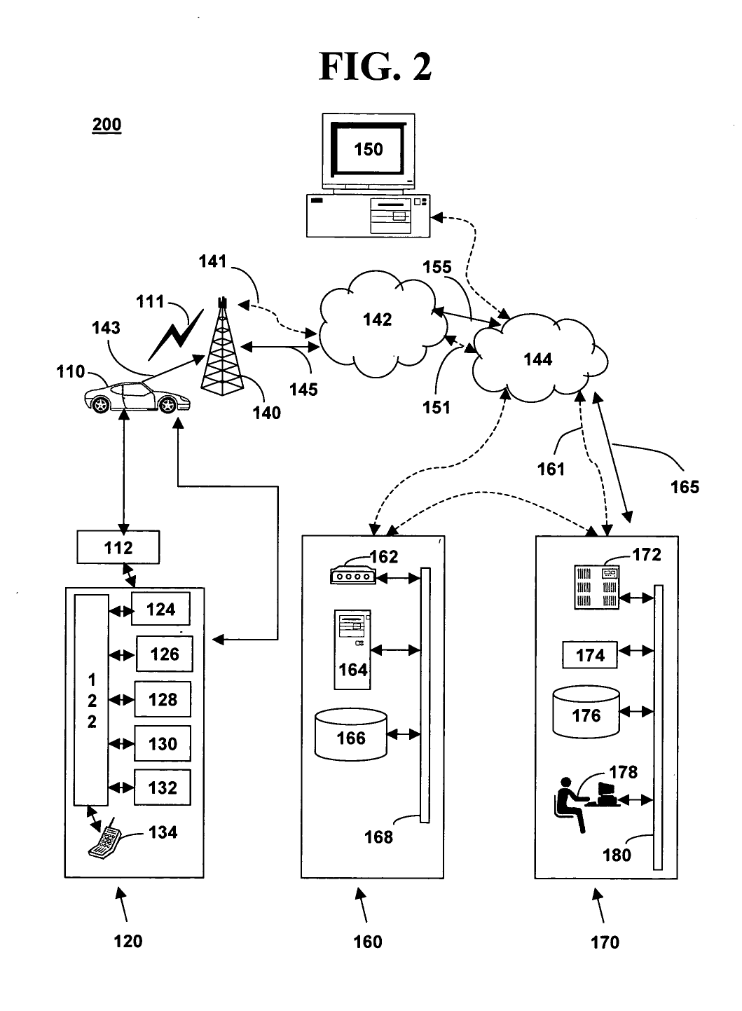

FIG. 2, in which like elements share like reference numbers with FIG. 1, is a schematic diagram of an embodiment of a telematics-unit access system 200 for providing access to a telematics unit 120 in a MVCU 110 in accordance with the present invention. Telematics-unit access system 200 is a first embodiment of a system for verifying a telematics unit 120 in the event of failure to connect a telematics unit 120 to a call center 170 by an authenticated call. An authenticated call is established as described in FIG. 1 by opening a communication channel from mobile MVCU 110 via telematics unit 120 through at least one of wireless carrier system 140, communication network 142 and land network 144 to web hosting portal 160 or call center 170. During an authenticated call, MVCU 110 connects to the wireless carrier system 140 by communication channel 111. During an authenticated call wireless carrier system 140 connects to communication network 142 by communication channel 141. During an authenticated call communication network 142 connects to land network 144 by communication channel 151. During an authenticated call land network 144 connects to call center 170 by communication channel 161.

After an authenticated call is established by an exchange of handshakes between the wireless modem 124 and a data modem 162 or a modem in call center 170, the software in the call center 170 is triggered to place an electronic request for MVCU 110 telematics unit identifiers from the telematics unit 120. The data supplied by an authenticated call includes the MVCU 110 identification number. The identification number of MVCU 110 includes data, such as, the MVCU's 110 longitude and latitude, the station identification for the telematics unit 120, and the method of triggering of the telematics unit. The identification number of MVCU 110 can also include data, such as, the mobile identification number of embedded or in-vehicle phone 134, the mobile dialable number of embedded or in-vehicle phone 134, the electronic serial number of the embedded or in-vehicle phone 134, or any combination of therein. The MVCU 110 telematics unit identifier data is supplied to a communications services advisor 178 who is in verbal communication with the user of the telematics unit 120.

In the event that an authenticated communication channel from mobile MVCU 110 to call center 170 is not established, one of the communication channels 111, 141, 151, 161 may not be connected. After a predetermined number of failures to establish an authenticated communication channel, the telematics unit 120 attempts to establish a cleared number voice call. During a cleared number voice call, MVCU 110 connects to the wireless carrier system 140 by communication channel 143. During a cleared number voice call wireless carrier system 140 connects to communication network 142 by communication channel 145. During a cleared number voice call, communication network 142 connects to land network 144 by communication channel 155. During a cleared number voice call, land network 144 connects to call center 170 by communication channel 165. Communication channel 165 can also include communication from land network 144 to web hosting portal 160 and from web hosting portal 160 to call center 170.

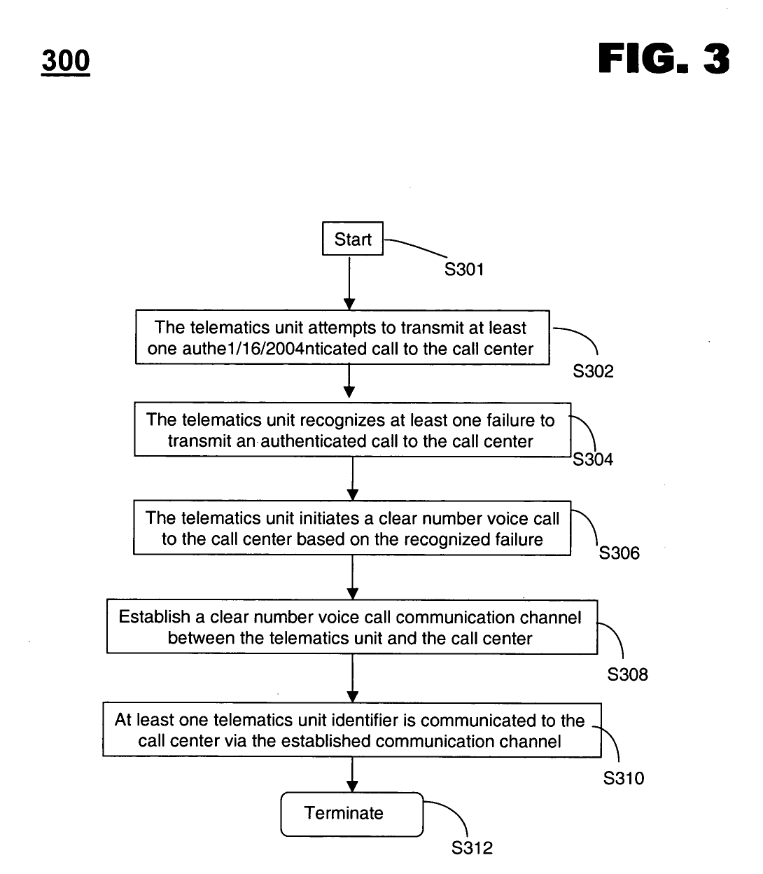

FIG. 3 illustrates a flowchart 300 representative of a portion of one embodiment of a method of verifying a telematics unit 120 in accordance with the present invention. The following discussion of flowchart 300 is related to exemplary telematics-unit access system 200 of FIG. 2. The method begins at S301.

During stage S302, the telematics unit 120 attempts to transmit at least one authenticated call to the call center 170. An authenticated call is initiated in response to input from the telematics unit 120. In one embodiment, the user in MVCU 110 pushes an emergency button to trigger the telematics unit 120 to initiate communication with the call center 170. In an alternative embodiment, the user in MVCU 110 pushes a non-emergency button to trigger the telematics unit 120 to initiate communication with the call center 170. In an alternative embodiment, deployment of airbags in MVCU 110 triggers the telematics unit 120 to initiate communication with the call center 170. In an alternative embodiment, telematics unit 120 senses that MVCU 110 was in a collision and is triggered to initiate communication with the call center 170.

During stage S304, the telematics unit 120 recognizes at least one failure to transmit an authenticated call to the call center 170 on at least one of communication channels 111, 141, 151, 161. The telematics unit 120 recognizes the failure to establish the authenticated call the telematics unit 120 by recognizing that a modem handshake at wireless modem 124 was not established after each attempt to establish the authenticated call. The telematics unit 120 will attempt to establish an authenticated call a predetermined number of times. In one embodiment, the telematics unit 120 will attempt to establish the call three times.

The failure to establish an authenticated call can be due to an error in the wireless modem 124, an error in the wireless carrier network 140, an error in the communications network 142, the land network 144, an error in the communication service manger 174, an error in the data modems 162, an error in the voice and data switches 172 or an error in the communications service data base 176.

During stage S306, the telematics unit 120 initiates a cleared number voice call to the call center 170 based on the recognized failure to transmit an authenticated call to the call center 170. A fail-safe mode in the hardware of the telematics unit 120 of MVCU 110 is triggered in the event that an authenticated communication channel from mobile MVCU 110 to call center 170 is not established. In this case, the telematics unit 120 initiates communication with the call center 170 using a cleared number voice call over a voice-only or cleared number voice call communication channel. In another embodiment, a cleared number is referred to as a non-validating number. The established cleared number voice call communication channel will not trigger the software in the call center 170 to place an electronic request for MVCU 110 telematics unit identifier from the telematics unit 120. The elimination of the data exchange inherent to an authenticated communication channel increases the probability of establishing communication with the call center 170.

During stage S308, a cleared number voice call communication channel, comprising at least one of communication channels 143, 145, 155 or 165, is established between the telematics unit 120 to the call center 170. The cleared number voice call voice does not trigger the software in the call center 170 to place an electronic request for MVCU 110 telematics unit identifier from the telematics unit 120. The communication services advisor 178 at the call center 170 must gain access to at least a portion of the data normally supplied after an authenticated call in another way.

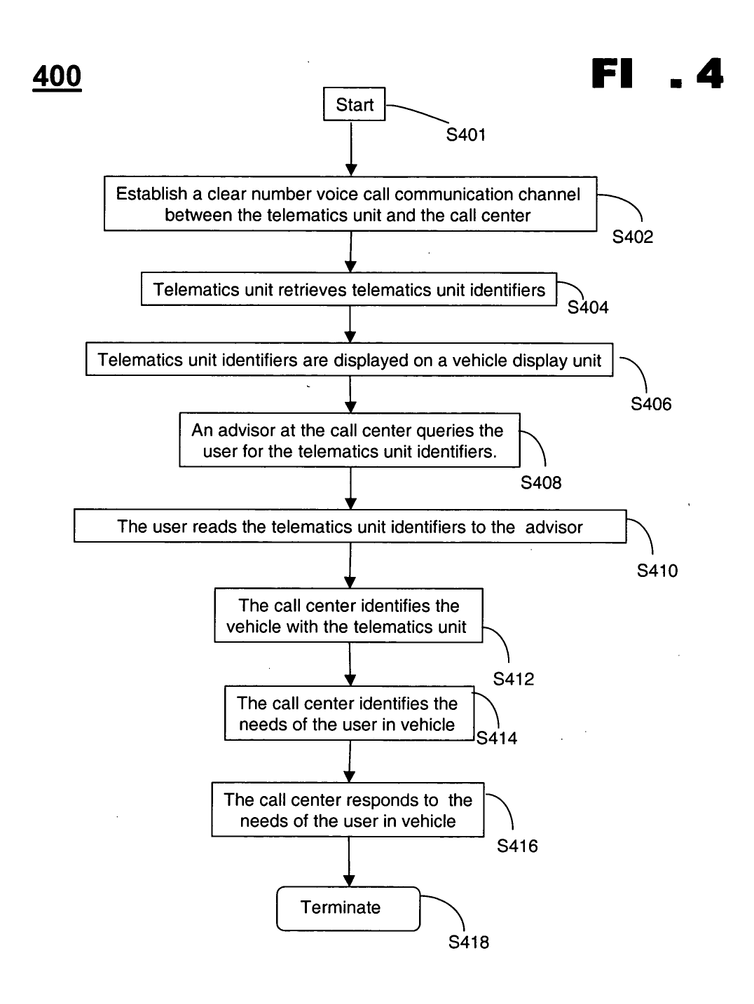

During stage S310, at least one of the telematics unit identifiers is communicated to the communication services advisor 178 at the call center 170 via the established cleared number voice call communication channel. The details of the various methods of communicating the telematics unit identifier are described in flowcharts 400, 500 and 600 of FIGS. 4, 5 and 6, respectively. During stage S312, the flow of flowchart 300 is terminated.

FIG. 4 illustrates a flowchart 400 representative of a second embodiment of a portion of a method of verifying a telematics unit 120 in accordance with the present invention. The following discussion of flowchart 400 is related to exemplary telematics-unit access system 200 of FIG. 2. The method steps begin at S401.

During stage S402, as described for stage S308 in FIG. 3, a cleared number voice call communication channel is established between the telematics unit 120 and the call center 170. The stages S404 through S412 provide detail about activities that occur during stage S310 in FIG. 3, according to one embodiment of the present invention.

During stage S404, the telematics unit 120 retrieves the telematics unit identifiers. When the cleared number voice call is initiated, the telematics unit identifiers are retrieved from memory 128 of the telematics unit 120. The identification number of MVCU 110 includes data, such as, the MVCU 110 longitude and latitude, the station identification for the telematics unit 120, and the method of triggering of the telematics unit. The identification number of MVCU 110 can also include data, such as, the mobile identification number of the embedded or in-vehicle phone 134, the mobile dialable number of the embedded or in-vehicle phone 134, the electronic serial number of the embedded or in-vehicle phone 134, or any combination of therein.

During stage S406, the retrieved telematics unit identifiers are displayed on a display in MVCU 110. The display may be the dialed digital display, such as, a radio unit or an instrument panel. When there are several telematics unit identifiers they may not fit on the display at the same time. In that case, the display scrolls through the various telematics unit identifiers displaying each identifier for a preset time, which can be 20 seconds. The display will show a first type of a telematics unit identifier along with the first telematics unit identifier value for the MVCU 110. After the preset time, the display will then show a second type a telematics unit identifier along with the second telematics unit identifier value for the MVCU 110. When all the telematics unit identifiers along with the correlated values have been displayed the display will scroll through again.

In an alternative embodiment, for example, when the display is small, the display will show a first type of telematics unit identifier for a first preset time, then the display will show the first telematics unit identifier value for the MVCU 110 for a second preset time. After the second preset time, the display will show a second type of telematics unit identifier for a first preset time, then the display will show the second telematics unit identifier value for the MVCU 110 for the second preset time. In one embodiment, the first and second preset times are equal.

In another alternative embodiment, the display will show a first type of telematics unit identifier and the corresponding first telematics unit identifier value on a first row, and the display will show a second type of telematics unit identifier and the corresponding second telematics unit identifier value on a second row.

In an alternative embodiment, all the telematics unit identifier types and the corresponding telematics unit identifier values are shown at the same time in a plurality of rows on the display. The display will not scroll in this case.

During stage S408, a communication services advisor 178 at the call center 170 queries the user of telematics unit 170 for the telematics unit identifiers. During stage S410, the user reads the telematics unit identifiers to the communication services advisor 178 over the open cleared number voice call communication channel. The telematics unit identifiers are visible on the display for the user to view. The user reads aloud the telematics unit identifiers from the display as the telematics unit identifiers scroll by on the display. The user reads aloud until the communication services advisor 178 has all the needed telematics unit identifiers.

During stage S412, the call center 170 identifies the MVCU 110 with the telematics unit 120, which sent the cleared number voice call. The call center 170 is able to identify the MVCU 110 after the communication services advisor 178 inputs the telematics unit identifiers, which were read by the user, into the communication server database 176 in the call center 170.

During stage S414, the call center 170 identifies the needs of the user in the MVCU 110. The needs of the user are identified, at least in part, by input about the method of triggering the communication from telematics unit 120 to call center 170. The method of triggering includes, at least, the user in MVCU 110 pushes an emergency button, the user in MVCU 110 pushes a non-emergency button, airbags are deployed in MVCU 110, or telematics unit 120 senses that MVCU 110 was in a collision. The communication services advisor 178 can also receive verbal information from the user in the vehicle over the open cleared number voice call communication channel comprising at least one of communication channels 143, 145, 155 or 165.

During stage S416, the call center responds to the needs of the user in the vehicle as appropriate for the needs of the user. During stage S418, the cleared number voice call is terminated. Termination will occur after the needs of the user have been addressed.

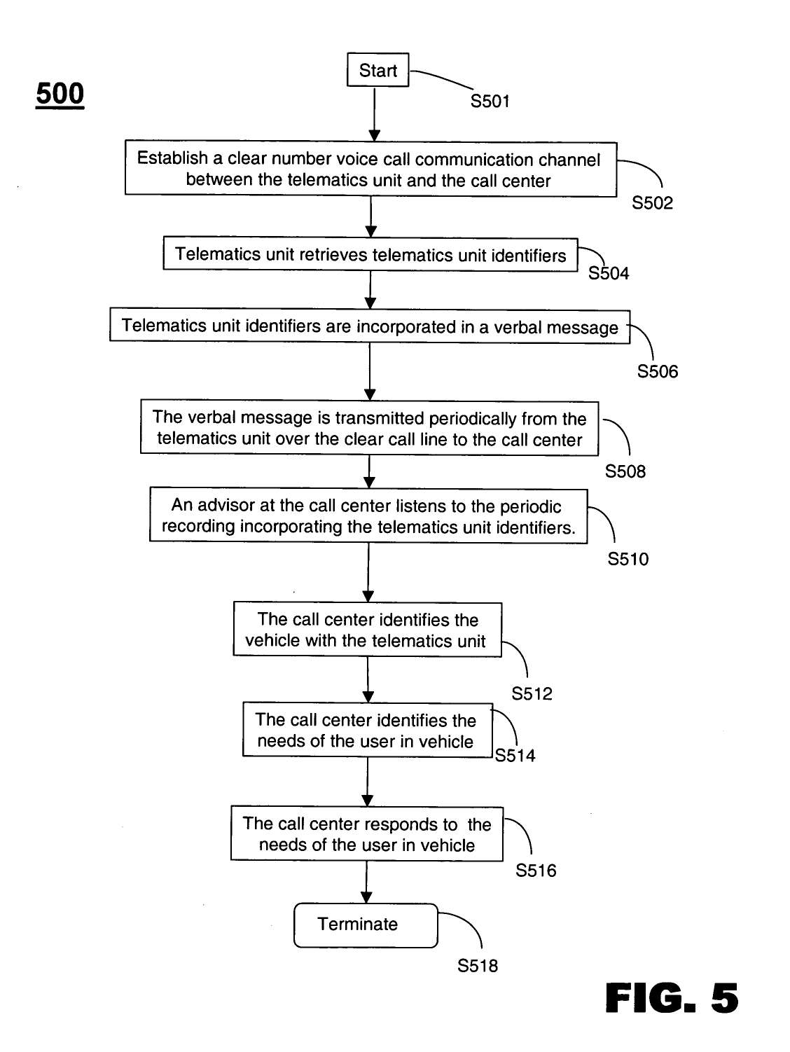

FIG. 5 illustrates a flowchart 500 representative of a third embodiment of a portion of a method of verifying a telematics unit in accordance with the present invention. The following discussion of flowchart 500 is related to exemplary telematics-unit access system 200 of FIG. 2. The stages S504 through S510 provide detail about activities that occur during stage S310 in FIG. 3, according to an embodiment of the present invention. The method steps begin at S501.

During stage S502, as described for stage S308 in FIG. 3, a cleared number voice call communication channel is established between the telematics unit 120 and the call center 170. During stage S504, the telematics unit 120 retrieves the telematics unit identifiers. When the cleared number voice call is initiated, the telematics unit identifiers are retrieved from memory 128 of the telematics unit 120. The identification number of MVCU 110 includes data, such as, the MVCU's 110 longitude and latitude, the station identification for the telematics unit 120, and the method of triggering of the telematics unit. The identification number of MVCU 110 can also include data, such as, the mobile identification number embedded or in-vehicle phone 134, the mobile dialable number embedded or in-vehicle phone 134, the electronic serial number of the embedded or in-vehicle phone 134, or any combination of therein.

During stage S506, the retrieved telematics unit identifiers are incorporated in a electronic verbal message within the telematics unit 120 of MVCU 110. During stage S508, the electronic verbal message is transmitted periodically from the telematics unit over the cleared number voice call communications channel to the call center 170.

The message will announce a first type of a telematics unit identifier and then announce the first telematics unit identifier value for the MVCU 110. The message will then announce a second type of a telematics unit identifier and then announce the second telematics unit identifier value for the MVCU 110. The types of telematics unit identifiers and the corresponding telematics unit identifier values will all be announced sequentially as the voice message is played. After all the telematics unit identifiers have been announced, the message will be replayed after a pause having a preset time. In one embodiment, the message is played with no pause between the first playing of the entire message and the second playing of the entire message. In an alternative embodiment, the message is played with a preset pause between the first playing of the entire message and a second playing of the entire message. In one embodiment, the preset pause lasts for 20 seconds.

In one embodiment, the electronic verbal message is played for the user to hear on the speakers 132. In this case the communication services advisor 178 will also hear the message over the open cleared number voice call communications channel comprising at least one of communication channels 143, 145, 155 or 165.

In an alternative embodiment, the electronic verbal message is played for the communication services advisor 178 to hear over the open cleared number voice call communications channel comprising at least one of communication channels 143, 145, 155 or 165 but the message is not played for the user on speakers 132.

During stage S510, a communication services advisor 178 at the call center 170 listens to the periodic recording incorporating the telematics unit identifiers. In one embodiment, the communication services advisor 178 can send a termination signal over the cleared number voice call communications channel to stop the playing of the recording. In one embodiment, the message continues until the cleared number voice call communications channel is closed by one party terminating the call.

During stage S512, the call center 170 identifies the MVCU 110 with the telematics unit 120, which sent the cleared number voice call. The call center 170 is able to identify the MVCU 110 after the communication services advisor 178 inputs the telematics unit identifiers, which were announced in the message, into the communication server database 176 in the call center 170.

During stage S514, the call center 170 identifies the needs of the user in the MVCU 110. The needs of the user are identified, at least in part, by input about the method of triggering the communication from telematics unit 120 to call center 170. The method of triggering the telematics unit 120 includes, at least, the user in MVCU 110 pushes an emergency button, the user in MVCU 110 pushes a non-emergency button, deployment of airbags in MVCU 110, or telematics unit 120 senses that MVCU 110 was in a collision. The communication services advisor 178 can also receive verbal information from the user in the vehicle over the open cleared number voice call communication channel comprising at least one of communication channels 143, 145, 155 or 165.

During stage S516, the call center responds to the needs of the user in the vehicle as appropriate for the needs of the user. During stage S518, the cleared number voice call is terminated. Termination will occur once all the needs of the user have been addressed.

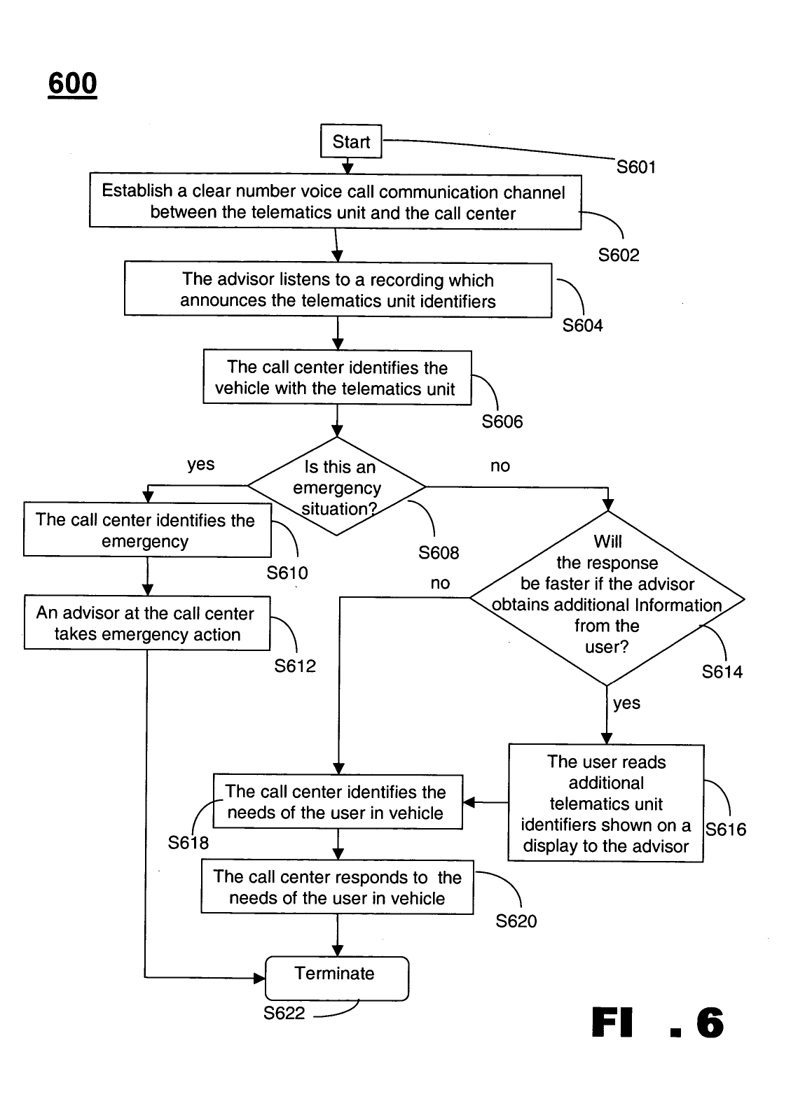

FIG. 6 illustrates a flowchart 600 representative of a fourth embodiment of a portion of a method of verifying a telematics unit in accordance with the present invention. The following discussion of flowchart 500 is related to exemplary telematics-unit access system 200 of FIG. 2 and flowcharts 400 and 500 of FIGS. 4 and 5, respectively. In this embodiment, the telematics unit 120 communicates the telematics unit identifiers both by announcing the telematics unit identifiers on the voice message and by showing the telematics unit identifiers on the display. The method steps begin at S601.

During stage 602, a cleared number voice call communication channel, comprising at least one of communication channels 143, 145, 155 or 165, is established between the telematics unit 120 to the call center 170. The cleared number voice call voice does not trigger the software in the call center 170 to place an electronic request for MVCU 110 telematics unit identifier from the telematics unit 120. The communication services advisor 178 at the call center 170 must gain access to at least a portion of the data normally supplied after an authenticated call in another way.

During stage S604, the communication services advisor 178 listens to a recording, which announces the telematics unit identifiers. The recording was formed as described in for stages S504, S506 and S508 of flowchart 500. In one embodiment of this portion of a method of verifying a telematics unit, the announced telematics unit identifiers are limited to a few critical items of information, such as, for example, the MVCU's 100 longitude and latitude, the station identification for the telematics unit 120, and the method of triggering of the telematics unit.

During stage S606 the call center 170 identifies the MVCU 110 with the telematics unit 120. The call center 170 is able to identify the MVCU 110 after the communication services advisor 178 inputs the announced telematics unit identifiers into the communication server database 176 in the call center 170.

During stage S608 it is determined if this is an emergency situation. The communication services advisor 178 will recognize if this is an emergency from the announced telematics unit identifiers. For example, the communication services advisor 178 knows this is an emergency situation if the cleared number voice call was triggered by a vehicle collision, by deployment of airbags in MVCU 110 or by a push of an emergency button on the telematics unit 120 by the user of MVCU 110.

If it is determined, during stage S608 that this is an emergency situation, the flow proceeds to stage S610. During stage S610, the call center identifies the emergency. The emergency identification will occur by the type of knowledge of the manner in which the call was initiated and, in some cases, by verbal communication with the user in the MVCU 110.

During stage S612 a communication services advisor 178 at the call center 170 takes appropriate emergency action. For example, if the user has been injured in a collision the call center and is unable to speak, the communication services advisor 178 will request that an ambulance and/or other appropriate emergency vehicles be sent to the location of the MVCU 110. If however, a vehicle collision initiated the call and the user tells the communication services that the collision is minor, the communication services advisor 178 may request that a police vehicle be sent to the location of the MVCU 110. The flow then proceeds to stage S622. During stage S622 the flow is terminated.

If it is determined, during stage S608 that this is not an emergency situation, the flow proceeds to stage S614. During stage S614, the communication services advisor 178 determines if the response will be faster if the user provides additional information by reading at least one telematics unit identifier from the display. Additional information may be required, for example, if the user is requesting information about the embedded or in-vehicle phone 134 in the MVCU 110. If the electronic serial number of the embedded or in-vehicle phone 134 was not in the recording played during stage S604, the communication services advisor 178 may find that it is quicker for the user to obtain the electronic serial number from the user.

If it is determined during stage S614 that it is not faster for the communication services advisor 178 to obtain additional information from the user, the flow proceeds to stage S618. During stage S618, the call center 170 uses the information input by the communication services advisor 178 and in the communication server database 176 and, in some cases, verbal communication with the user in the MVCU 110 to identify the needs of the user in the vehicle. Then the flow proceeds to stage S620.

If it is determined during stage S614 that it is faster for the communication services advisor 178 to obtain additional information from the user, the flow proceeds to stage S616. During stage S616, the user reads the additional telematics unit identifiers shown on a display to the communication services advisor 178. The information was input on the display in the process described during stages S404 and S406 in flowchart 400 of FIG. 4. Then the flow proceeds to stage S618. During stage S618 the call center 170 identifies the needs of the user in the MVCU 110 as described above.

During stage S620 the call center 170 responds to the needs of the user in MVCU 110. During stage S622 the flow is terminated.

The first portion of the method of method of verifying a telematics unit is described in FIG. 3. This portion relates to the failure to establish an authenticated call and the establishment of the cleared number voice call communication channel. The second portion of the method of verifying a telematics unit 120 in which details of how the telematics unit identifier is communicated to the call center 170 and how the call center 170 responds to the user's needs are described in FIGS. 4, 5 and 6. An embodiment comprising a combination of the second portions described in FIGS. 4 and 5 of the method of verifying a telematics unit is described in FIG. 6. Alternative embodiments comprising a combination of the second portions described in FIGS. 4 and 5 of the method of verifying a telematics unit can be envisioned by one of ordinary skill in the art.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of verifying a telematics unit, the method comprising:
initiating a cleared number voice call from a telematics unit to a call center based on a failed transmission condition;
establishing a cleared number voice call communication channel between the telematics unit and the call center; and
communicating at least one telematics unit identifier to the call center via the established communication channel.

2. The method of claim 1, wherein initiating a cleared number voice call from a telematics unit to a call center based on a failed transmission condition further comprises:
attempting to transmit at least one authenticated call from the telematics unit to the call center;
recognizing at least one failure to transmit an authenticated call from the telematics unit to the call center; and
transmitting the cleared number voice call from the telematics unit to the call center based on the recognized failure.

3. The method of claim 2, wherein the at least one failure comprises three failures.

4. The method of claim 1, wherein communicating at least one telematics unit identifier to the call center responsive to the initiated cleared number voice call further comprises:
displaying the telematics unit identifier on a display at the telematics unit; and
communicating the displayed unit identifier over the cleared number voice call communication channel by the user wherein the call center identifies a vehicle.

5. The method of claim 1, wherein communicating at least one telematics unit identifier to the call center responsive to the initiated cleared number voice call further comprises:
initiating a verbal recording including the telematics unit identifier at the telematics unit upon establishment of the cleared number voice call communication channel; and
communicating the telematics unit identifier over the cleared number voice call communication channel wherein the call center identifies a vehicle.

6. The method of claim 5 wherein the verbal recording is initiated periodically for communication to the call center.

7. The method of claim 1, wherein the telematics unit identifiers are selected from the group consisting of station identification number, mobile identification number, mobile dialable number, electronic serial number, vehicle location, vehicle identification number and combinations thereof.

8. A system of verifying a telematics unit comprising:
means for initiating a cleared number voice call from a telematics unit to a call center based on a failed transmission condition;
means for establishing a cleared number voice call communication channel between the telematics unit and the call center; and
means for communicating at least one telematics unit identifier to the call center responsive to the established cleared number voice call.

9. The system of claim 8, wherein the means for initiating a cleared number voice call from a telematics unit to a call center based on a failed transmission condition further comprises:
means for attempting to transmit at least one authenticated call from the telematics unit to the call center;
means for recognizing at least one failure to transmit an authenticated call from the telematics unit to the call center; and
means for transmitting the cleared number voice call from the telematics unit to the call center based on the recognized failure.

10. The system of claim 8, wherein the means for communicating at least one telematics unit identifier to the call center responsive to the established cleared number voice call further comprises:
means for displaying the telematics unit identifier on a display at the telematics unit;
means for communicating the displayed unit identifier over the cleared number voice call communication channel by the user wherein the call center identifies a vehicle; and
means for terminating the displaying of the unit identifier when communication of the unit identifier is complete.

11. The system of claim 8, wherein the means for communicating at least one telematics unit identifier to the call center responsive to the established cleared number voice call further comprises:
means for displaying the telematics unit identifier on a display at the telematics unit;
means for initiating a verbal recording including the telematics unit identifier by the telematics unit upon establishment of the cleared number voice call communication channel; and
means for communicating the telematics unit identifier over the cleared number voice call communication channel wherein the call center identifies a vehicle.

12. A computer readable medium storing a computer program comprising:
computer readable code for initiating a cleared number voice call from the telematics unit to the call center based on a failed transmission condition;
computer readable code for establishing a cleared number voice call communication channel between the telematics unit and the call center; and
computer readable code for communicating at least one telematics unit identifier to the call center responsive to the established cleared number voice call.

13. The medium of claim 12, wherein initiating a cleared number voice call from a telematics unit to a call center based on a failed transmission condition further comprises:
computer readable code for attempting to transmit at least one authenticated call from the telematics unit to the call center;
computer readable code for recognizing at least one failure to transmit an authenticated call from the telematics unit to the call center; and
computer readable code for transmitting the cleared number voice call from the telematics unit to the call center based on the recognized failure.

14. The medium of claim 12, wherein the at least one failure comprises three failures.

15. The medium of claim 12, wherein communicating at least one telematics unit identifier to the call center responsive to the initiated cleared number voice call further comprises:
computer readable code for displaying the unit identifier on a display at the telematics unit;
computer readable code for communicating the displayed telematics unit identifier over the cleared number voice call communication channel by the user wherein the call center identifies a vehicle; and
computer readable code for terminating the displaying of the unit identifier when communication of the unit identifier is complete.

16. The medium of claim 12, wherein communicating at least one telematics unit identifier to the call center responsive to the initiated cleared number voice call further comprises:
computer readable code for initiating a verbal recording including the telematics unit identifier by the telematics unit upon establishment of the cleared number voice call communication channel;
computer readable code for communicating the telematics unit identifier over the cleared number voice call communication channel wherein the call center identifies a vehicle; and
computer readable code for terminating the verbal recording when communication of the unit identifier is complete.

17. The medium of claim 16 wherein the verbal recording is initiated periodically for communication to the call center.

18. The medium of claim 12, wherein the telematics unit identifiers are selected from the group comprising station identification number, mobile identification number, mobile dialable number, electronic serial number and combinations thereof.
